(19) United States
(12) Patent Application Publication
(10) Pub. No.: US 2013/0264425 A1
(43) Pub. Date: Oct. 10, 2013

(54) SEPARABLE STREAMLINED NOSE CONE FOR A GUIDED MUNITION, AND GUIDED MUNITION INCLUDING SUCH A NOSE CONE

(71) Applicants: Patrick Cohe, Neuvy En Sullias (FR); Fabien Moreau, La Ferte St Aubin (FR)

(72) Inventors: Patrick Cohe, Neuvy En Sullias (FR); Fabien Moreau, La Ferte St Aubin (FR)

(73) Assignee: TDA ARMEMENTS SAS, La Ferte Saint-Aubin (FR)

(21) Appl. No.: 13/882,398

(22) PCT Filed: Oct. 25, 2011
(86) PCT No.: PCT/EP2011/068688

§ 371 Date: Jun. 10, 2013

(30) Foreign Application Priority Data
Oct. 29, 2010 (FR) 1004269

(51) Int. Cl. B64C 1/38

(52) U.S. Cl. CPC B64C 1/38
USPC 244/130

(57) ABSTRACT

A separable ejectable protective nosecone for a guided munition comprises a munition body of cylindrical shape of longitudinal axis ZZ′ having a munition body front end comprising a central part intended to be directed toward a target of the munition. The nosecone comprises, at the munition body front end and covering said front end, n contiguous nosecone portions of the same shape distributed about said longitudinal axis ZZ′, one respective pyrotechnic device per nosecone portion. Each of the pyrotechnic devices comprises a pyrotechnic device body secured to the munition body, a pusher piston in contact with the respective nosecone portion. Simultaneous activation of the n pyrotechnic devices separates the edges of the nosecone portions from their respective plane of assembly in order to free the front end of the munition body. Application: Steered or guided munitions such as those of the rocket or projectile type or missiles.

The invention relates to the nosecones that protect the homing head of guided munitions and, more particularly, of munitions of limited length.

Guided or steered munitions, such as those of the rocket or projectile or missile type, are equipped with optical and electronic guiding systems so that, after a phase of flight that is followed by a target approach phase, the munition can be guided with great reliability and precision into impact on the target.

For example, certain types of guided missiles or rockets are steered using a laser beam. Missile optics detect the laser beam illuminating the target and a computer on board the missile determines the flight parameters required in order to reach the target.

In general, the guidance optics situated in the front end (nose or head) of the missile or of the guided munition in a more general case, namely in that end of the munition which is directed toward the target, comprises a separable protective nosecone which, on the one hand, protects the homing head optics from impacts with foreign bodies present in the air during the flight phase and, on the other hand, prevents an increase in temperature of the missile guidance electronics associated with the homing head optics as a result of aerodynamic friction of the head of the munition.

This nosecone may also protect the guidance optics of the munition, as appropriate, during a firing phase for example when passing through a diaphragm; during a ballistic phase, in the case of a rocket or of a projectile; during a cruising phase in the case of missiles.

After a (ballistic or cruising) approach phase, the munition enters a steered guidance phase. To make the latter phase operative, an ejection system has to be provided in order to free the optics emergent part of the homing head.

Because of their large size, the ejectable protective nosecones of the prior art which protect homing head optics are not suited to munitions of limited length.

In order to alleviate the disadvantages of the guided munitions of the prior art, the invention proposes a separable ejectable protective nosecone for a guided munition comprising a munition body (10) of cylindrical shape of longitudinal axis ZZ′ having a munition body front end (12) comprising a central part (14) intended to be directed toward a target,

the nosecone comprising n nosecone portions C1, C2, . . . Ci, . . . Cn of the same shape, distributed about said longitudinal axis ZZ′, intended to cover the front end (12) of the munition body, n being an integer equal to or greater than 2, it being the rank of the nosecone portion, a nosecone portion Ci having at least one edge (90, 92) in contact with one edge of a nosecone portion contiguous with it in a respective plane of assembly (P1, P2, P3) of two contiguous nosecone portions passing through the longitudinal axis ZZ′, one pyrotechnic device (30, 32) per nosecone portion (C1, C2, C3, C4), each of the pyrotechnic devices comprising, along their longitudinal axis AA′, a pyrotechnic device body (40) secured in terms of translational movement to the munition body (10), a pusher piston (42) able to slide in a manner that is fluid-tight via one of its ends, along the longitudinal axis AA′, on the pyrotechnic device body (40), the free end of the pusher piston being in contact with the respective nosecone portion (C1, C2, C3, C4) in order, when the n pyrotechnic devices are simultaneously activated, to separate the contacting edges (90, 92) of the n nosecone portions from their respective planes of assembly and to free the front end (12) of the munition body,

The nosecone comprises an ovoid part at the front end (12) of the munition body (10) extending toward the rear of said munition body in the form of a frustoconical part (104) of longitudinal axis ZZ′ comprising an edge (106) that is circular around said ZZ′ and, in the zone where the ovoid part and the frustoconical part meet, weakening grooves of circular shape around the longitudinal axis ZZ′, there being an external weakening groove (110) on the external surface side thereof and an internal weakening groove (112) on the internal surface side thereof.

Advantageously, in one embodiment of the separable ejectable nosecone, n being equal to 2, the nosecone portions are half-nosecones, a lower half-nosecone and an upper half-nosecone the shapes of which exhibit symmetry about the plane of assembly.

In one embodiment, each nosecone portion is in contact with the pusher piston of a respective pyrotechnic device via a reaction finger solid with the nosecone portion.

In another embodiment, each pyrotechnic device comprises an igniter between the pyrotechnic device body and the pusher piston so that when activated it separates the pusher piston from the pyrotechnic device body and applies a separation force F to the respective nosecone portion.

In another embodiment, the other free end of the pusher piston comprises a pusher piston head forming, on the same side as the pyrotechnic device body, a shoulder having a surface with a back slope intended to be in contact with another surface having the same back slope belonging to the reaction finger of said nosecone portion and, at this same other free end of the pusher piston, on the side nearest the munition body, a longitudinal groove parallel to the axis AA′, a cylindrical pin adhered by one of its ends to the munition body being inserted via the other end into the longitudinal groove to limit the travel of the pusher piston of the pyrotechnic device when the igniter is activated.

In another embodiment, the pyrotechnic device body comprises an electrical connection pin intended to receive electrical wires for activating the igniter.

In another embodiment, the lower half-nosecone and upper half-nosecone each comprise a respective edge in contact in the plane of assembly P1, the lower half-nosecone comprising on its edge a longitudinal groove extending on each side of the axis ZZ′, the upper half-nosecone comprising on its edge, in a manner which is symmetric about the plane of assembly (P1), a longitudinal tenon extending on each side of the axis ZZ′ with the same external dimensions as the longitudinal groove in order to form a nested connection of the tenon/mortise type.

In another embodiment, the separable ejectable nosecone comprises, surrounding the frustoconical part, a retaining ring that holds the n nosecone portions on the munition body, said retaining ring being held on the n nosecone portions by bonding, crimping or push fitting.

In another embodiment, the retaining ring comprises, on one side, a tapered edge in the region of the frustoconical part having the weakening grooves and, on the opposite side, toward the rear of the munition, a circular edge in the plane P4 perpendicular to the longitudinal axis ZZ′.

In another embodiment, the separable ejectable nosecone comprises, on the side of the frustoconical part, a circular nosecone edge, the circular nosecone edge and the circular edge of the retaining ring being in abutment, in the same plane P4, against a shoulder, in a plane perpendicular to the longitudinal axis ZZ′, of the munition body

In one embodiment of a munition comprising the separable ejectable nosecone according to the invention, with the smallest diameter of the frustoconical part of the nosecone being on the side facing toward the rear of the munition to create a back slope a that holds the half-nosecones on the munition body, the munition body comprises a circular zone around the axis ZZ′ the external surface of which circular zone has the same retaining back slope as the internal surface of the frustoconical part so as to hold the two half-nosecones on the munition body

A key objective of the invention is to create small-sized ejectable protective nosecones for guided munitions of limited length.

Another objective is to create a streamlined nosecone which, after the nosecone has been ejected, leaves the munition with a streamlined profile similar to the profile it had before the nosecone was ejected.

The invention will be better understood with the aid of one exemplary embodiment of a guided munition according to the invention, given with reference to the indexed drawings in which:

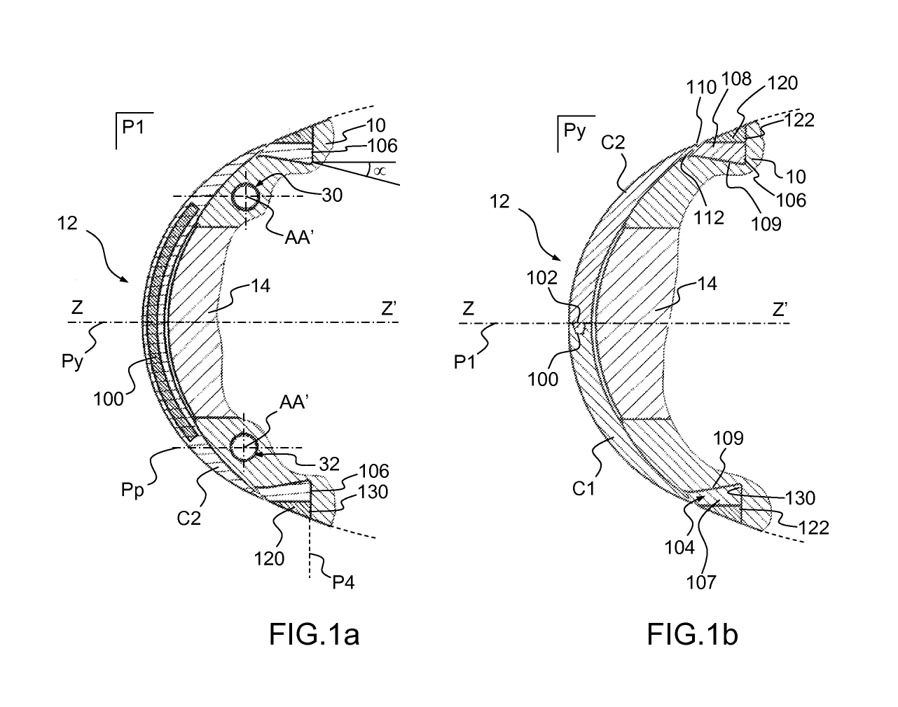

FIG. 1a shows a partial view in axial section of the front end of a guided munition equipped with a separable ejectable protective nosecone according to the invention;

FIG. 1b shows a partial view in axial section perpendicular to the axial section of the front end of the munition of FIG. 1a;

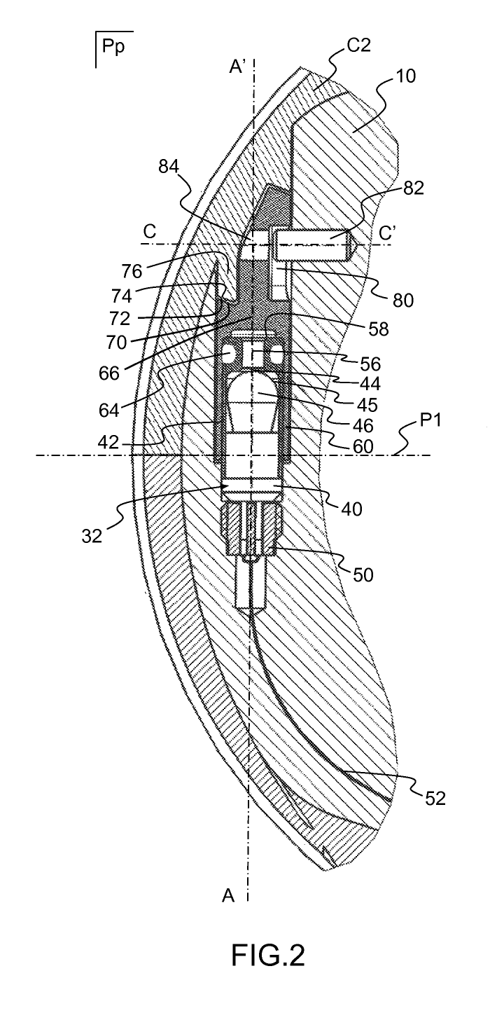

FIG. 2 shows a partial view in section of one of the pyrotechnic devices of the munition of FIGS. 1a and 1b;

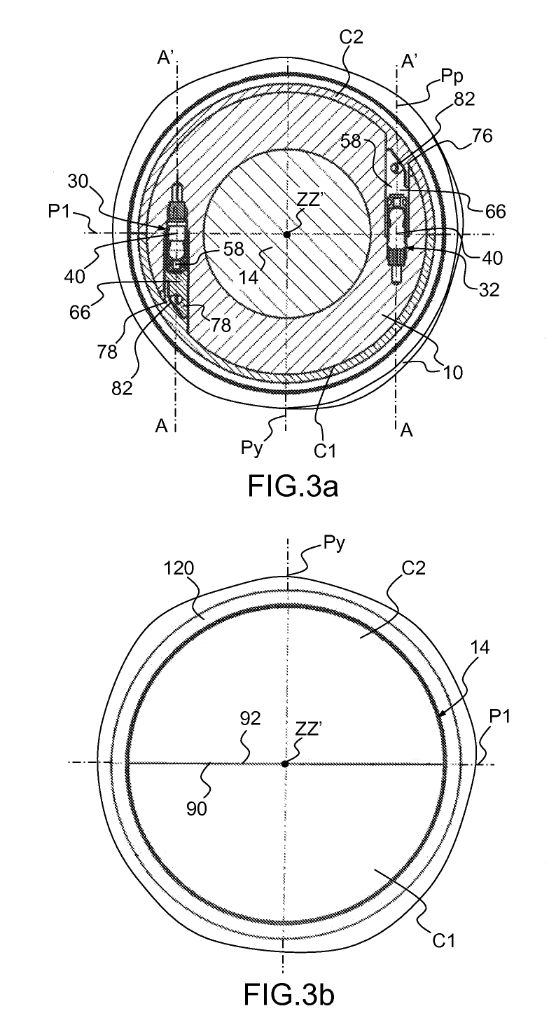

FIG. 3a shows a transverse section view of the munition of FIG. 1a:

FIG. 3b shows a face-on view of the munition of FIG. 1a fitted with its separable ejectable nosecone;

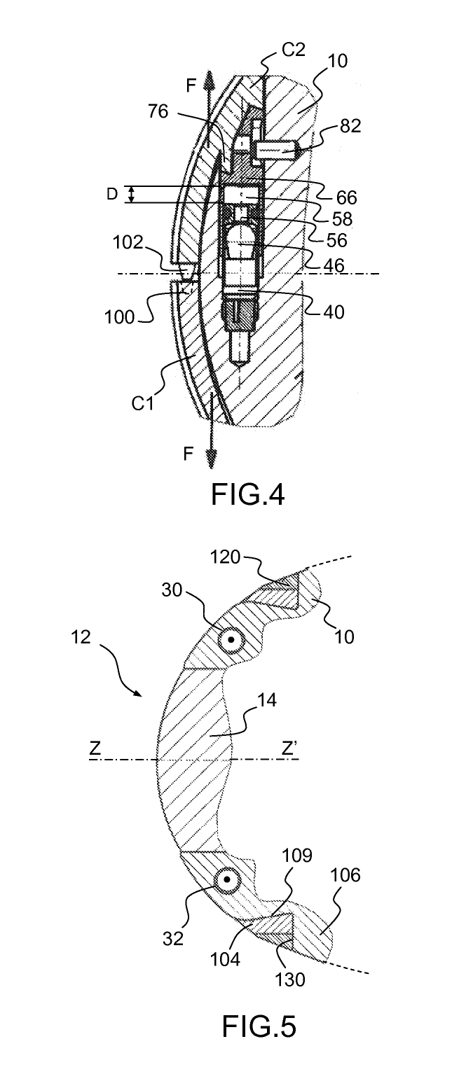

FIG. 4 shows a partial view of the half-nosecones of FIG. 1b as they separate;

FIG. 5 shows a view in axial section of the munition of FIG. 1b after the separable ejectable nosecone has been ejected;

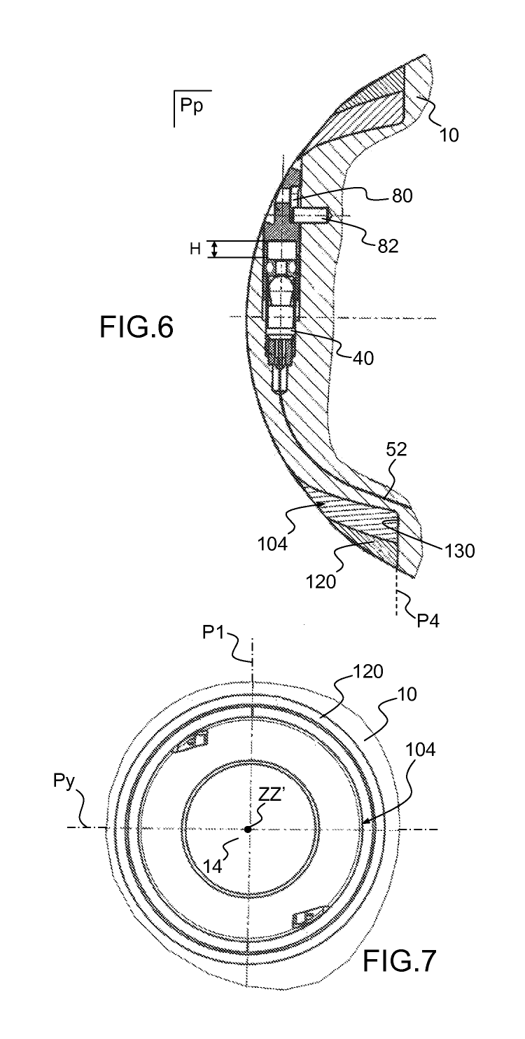

FIG. 6 shows a view in cross section of one of the pyrotechnic devices of the munition after the nosecone has been ejected;

FIG. 7 shows a face-on view of the munition after the nosecone has been ejected;

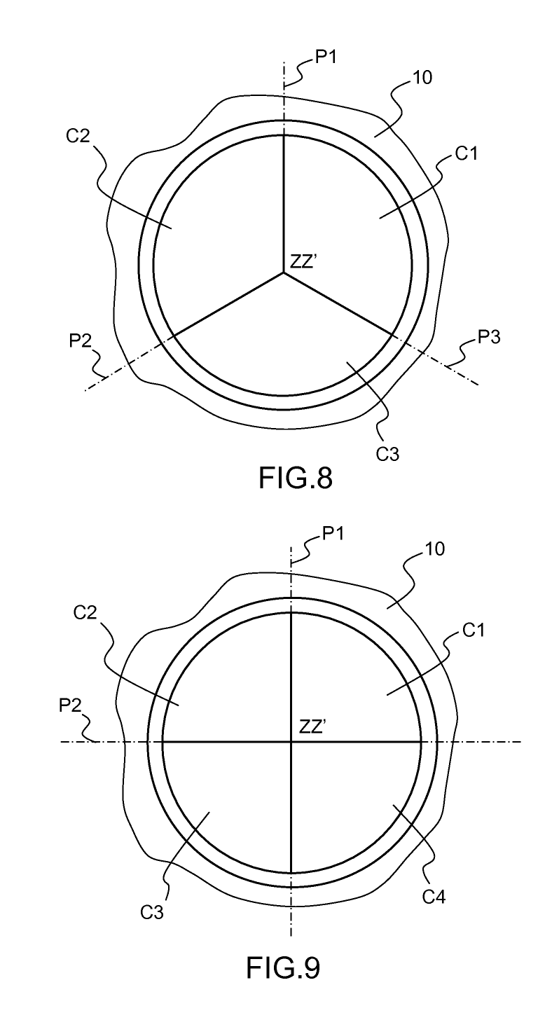

FIG. 8 shows a face-on view of a separable ejectable nosecone according to the invention made from three contiguous nosecone portions; and

FIG. 9 shows another exemplary embodiment of a separable ejectable nosecone according to the invention comprising four identical nosecone portions.

FIG. 1a shows a partial view in axial section of the front end of a guided munition equipped with a separable ejectable protective nosecone according to the invention.

FIG. 1b shows a partial view in axial section perpendicular to the axial section of the front end of the munition of FIG. 1a.

The munition of FIGS. 1a and 1b comprises a munition body 10 having a front end 12 of said munition body 10 covered by the separable ejectable nosecone according to the invention. A central part 14 of the munition body 10 may, for example, contain munition homing head optics (not depicted in the figures).

The separable ejectable protective nosecone in this exemplary embodiment comprises two nosecone portions C1, C2, i.e. n=2.

In this embodiment the two nosecone portions are two half-nosecones, a lower half-nosecone C1 and an upper half-nosecone C2 of shapes which exhibit symmetry with respect to a plane of assembly P1 of the two half-nosecones passing through the longitudinal axis ZZ′ with the munition body 10.

The separable ejectable nosecone comprises, on each side of a plane PY passing through the axis ZZ′ perpendicular to the plane of assembly P1 and equidistance from the axis ZZ′, two pyrotechnic devices of longitudinal axis AA′, secured to the munition body 10. The pyrotechnic devices are intended, when activated, to apply forces for separating the half-nosecones.

In this embodiment, the separable ejectable nosecone comprises a right-hand pyrotechnic device 30 to apply a force F to the lower half-nosecone C1, and a left-hand pyrotechnic device 32 to apply a force F of the same magnitude for the opposite direction, to the upper half-nosecone C2.

FIG. 2 shows a partial view in cross section of one of the pyrotechnic devices of the munition of FIGS. 1a and 1b.

In this embodiment, the pyrotechnic devices are of the igniter type.

FIG. 2 in particular shows a view in section of the left-hand pyrotechnic device 32 on a plane Pp parallel to the plane Py passing through the longitudinal axis AA′ of action of said left-hand pyrotechnic device.

Each pyrotechnic device comprises, along its longitudinal axis AA′, a pyrotechnic device body 40 and a pusher piston 42 able to slide in a manner that is fluid-tight on the pyrotechnic device body 40 along the longitudinal axis AA′. The pyrotechnic device body 40 comprises, on the same side as the pusher piston 42, a cylindrical sleeve 44, having a cavity 45 and, in this cavity 45, an igniter 46 for releasing pressurized gases into the cavity 45. To this end, the pyrotechnic device body 40 comprises an electrical connection pin 50 intended to receive electrical wires 52 for activating the igniter 46.

The cylindrical sleeve 44 further comprises a passage 56, along the axis AA′, for the passage of the gases produced by the igniter 46 to a chamber 58 formed between the pusher piston 42 and the cylindrical sleeve 44.

At one of its two ends on the same side of the pyrotechnic device body 40, the pusher piston 42 comprises a cylindrical wall 60 able to slide in a manner that is fluid-tight on the cylindrical sleeve 44 of the pyrotechnic device. The cylindrical sleeve 44 comprises a seal 64 on its periphery in a plane perpendicular to the longitudinal axis AA′, in contact with an internal surface of the cylindrical wall 60 in order to achieve sealing between pusher piston and cylindrical sleeve.

The pusher piston 42 at its other free end comprises a pusher piston head 66 which, on the same side as the pyrotechnic device body 40, forms a shoulder 70 having a surface 72 at a back slope intended to be in contact with another surface 74 at the same back slope belonging to a reaction finger 76 solid with the respective half-nosecone with the pyrotechnic device in question.

The reaction finger 76 of each half-nosecone amongst other things allows the half-nosecones C1, C2 to be positioned angularly on the munition body 10.

On the same side as this same other free end of the pusher piston 42, near the munition body 10, the pusher piston head 66 comprises a longitudinal groove 80 parallel to the longitudinal axis AA′. A cylindrical pin 82 secured by one of its ends to the munition body 10 is inserted via its other end into the longitudinal groove 80 to limit the travel of the pusher piston 42 when the igniter 46 of the pyrotechnic device is activated.

Because the pyrotechnic device 30, 32 is mounted on the munition body, the pusher piston head 66 comprises a hole 84 of axis CC′ perpendicular to the axis AA′ opening into the groove 80 for the insertion of the pin 82 into the munition body 10.

FIG. 3a shows a transverse section view of the munition of FIG. 1a.

The transverse view of FIG. 3a is a section on a plane normal to the axis ZZ′ passing through the axis AA′ of the right-hand and left-hand pyrotechnic devices 30 and 32 respectively.

The pyrotechnic devices 30, 32 are mounted top to tail on each side of the plane PY. The bodies 40 of the pyrotechnic devices are secured to the munition body 10 and prevented from translational movement along their longitudinal axis AA′ in the munition body 10.

The pusher piston 42 of the left-hand pyrotechnic device 32 is in contact, as already described, with the upper half-nosecone C2 by its reaction finger 76. In a manner that is symmetric with respect to the plane PY but inverted with respect to the plane of assembly P1, the pusher piston 42 of the right-hand pyrotechnic device 30 is in contact with the lower half-nosecone C1 via the reaction finger 76 of said lower half-nosecone C1.

FIG. 3b shows a face-on view of the munition of FIG. 1a equipped with its separable ejectable nosecone.

The lower half-nosecone C1 and upper half-nosecone C2 each comprise a respective edge 90, 92 in contact with one another in the plane of assembly P1 closing the separable ejectable nosecone of the munition.

To ensure that the nosecone is perfectly hermetically sealed, the lower half-nosecone C1 comprises, on its edge 90 lying in the plane of assembly P1, a longitudinal groove 100 which extends from each side of the axis ZZ′. The upper half-nosecone C2 comprises, in a way that is symmetric with respect to the plane of assembly P1, on its edge 92 situated in said plane of assembly P1, a longitudinal tenon 102 extending on each side of the axis ZZ′ and with the same external dimensions of the longitudinal groove 100 in order, when the two half-nosecones C1, C2 are in contact, to form a nested assembly of the tenon/mortise type (FIG. 1b).

The two half-nosecones C1, C2 assembled to form the small-sized separable ejectable nosecone according to the invention, as has been depicted in FIGS. 1a and 1b, closely envelop the front body 12 of the munition body 10 by a part of ovoid shape of axis of revolution ZZ′ which is formed by a lower half-ovoid shape of the lower half-nosecone C1 and an upper half-ovoid shape of the upper half-nosecone C2.

The ovoid part of the separable ejectable nosecone is extended toward the rear of the munition in the form of a frustoconical part 104 of axis ZZ′ comprising a nosecone edge 106 which is circular around the axis ZZ′ of the munition body 10, a lower frustoconical half-part 107 for the lower half-nosecone C1 and an upper frustoconical half-part 108 for the upper half-nosecone C2.

The smallest diameter of the frustoconical part of the nosecone faces toward the rear of the munition to create a back slope a that holds the separable ejectable nosecone on the munition body 10. To achieve that, the munition body 10 comprises a zone 109 that is circular about the axis ZZ′ the external surface of which has the same retaining back slope as the internal surface of the frustoconical part 104 of the separable ejectable nosecone so as to hold the separable ejectable nosecone (or the two half-nosecones) on the munition body 10.

The zones where the ovoid part and the frustoconical part of the separable ejectable nosecone meet comprises weakening grooves around the nosecone which are of circular shape with axis ZZ′, there being an external weakening groove 110 on the external surface of the nosecone and an internal weakening groove 112 on the internal surface of the separable ejectable nosecone.

The two half-nosecones are held on the munition body 10 by a retaining ring 120 surrounding the frustoconical part. The retaining ring 120 comprises, on one side, an edge which is tapered in the region of the frustoconical part 104 comprising the weakening grooves 110, 112 of the nosecone and, on the opposite side, facing toward the rear of the munition, a circular ring edge 122 in a plane P4 perpendicular to the axis ZZ′.

The circular nosecone edge 106 and the circular edge 122 of the retaining ring 120 are in abutment, in the one same plane P4, against a shoulder 130, in a plane perpendicular to the longitudinal axis ZZ′, of the munition body 10.

The retaining ring 120 may be fixed to the frustoconical part 104 of the nosecone by adhesive bonding. Likewise, the frustoconical part of the nosecone may also be bonded to the circular zone 109 of the munition body to confer greater rigidity and security of attachment of the separable ejectable nosecone to the munition.

The principle of the ejection of the nosecone according to the invention is explained hereinbelow.

During the approach phase in which the munition nears the target, the munition homing head optics, at the front of the munition body, is protected by the separable ejectable nosecone.

As the munition nears the target a final phase in which the munition is guided begins. During this final phase, the nosecone needs to be ejected.

Just prior to the munition guidance/steering phase, an electric impulse is sent by the munition on-board electronics to the two pyrotechnic devices 30, 32 via the electric power supply wires 52 (see FIG. 2). This electric impulse simultaneously initiates the igniters 46 of the two pyrotechnic devices 30, 32 positioned top to tail as depicted in FIG. 3a.

The igniters 46 therefore generate pressurized gases in the cavity 45 of the respective cylindrical sleeves 44.

In other embodiments of the nosecone, according to the invention, the igniters may be supplemented by an additional charge.

The gases arrive under pressure through the passages 56 in the chambers 58 of the two pyrotechnic devices 30, 32. The pressure of the gases tends to increase the volume of the chambers 58 (height D of the chamber) very rapidly driving the pusher piston 42 away from the pyrotechnic device body 40 and therefore causing the two half-nosecones to separate from the plane of assembly P1 through the application of a respective force F along the axis AA′ of the pusher piston.

The two half-nosecones, subjected to the forces F, break at the weakening grooves 110, 112 and are ejected from the munition, freeing the front end 12 of the munition body 10.

The two pusher pistons are retained at the end of their travel by the respective pins 82 butting against the lower edge of the grooves 80 in the head of the pusher pistons, preventing any ejection of metallic components that could impact with the munition. The piston heads toward the end of their travel are positioned flush with the external profile of the munition in order to obtain another streamlined profile in keeping with the previous one. The pressure of the gases in the chamber 58 of the pyrotechnic devices is maintained by virtue of the seal 64, the pusher pistons 42 thus remaining locked in their end-of-travel position.

FIG. 4 shows a partial view of the half-nosecones of FIG. 1b while they are separating. The two pusher piston heads 66 press against the respective reaction fingers 76 of the lower half-nosecone C1 and upper half-nosecone C2 which, as they separate, break along their weakening grooves 110, 112. The retaining ring 120 holds the frustoconical part 104 of the two half-nosecones on the munition body 10.

FIG. 5 shows a view in axial section of the munition of FIG. 1b after the separable ejectable nosecone has been ejected.

The back slope of the surface 72 of the pusher piston head and the identical one on the other surface of the reaction finger 76 of the half-nosecones have the function of ensuring, during the phase in which the two half-nosecones are being ejected, that the pusher piston heads 66 and the retaining fingers 76 of the half-nosecones are correctly secured.

FIG. 6 shows a view in cross section of one of the pyrotechnic devices of the munition after the nosecone has been ejected. The chamber has adopted its maximum height H when the pin 82 has come into abutment at the end of the groove 80.

The separation of the two half-nosecones by the pyrotechnic devices also allows air to rush in at high speed through the opening in the plane of assembly P1 that appears as the edges 90, 92 of the two half-nosecones separate, thus making them easier to eject.

In the event of munitions which rotate (spin) on themselves, the components generated by centrifugal force also contribute to ejecting the two half-nosecones.

After the half-nosecones have been ejected, the munition once again has an aerodynamic profile very similar to the initial profile it had prior to ejection, so this does not in any way disturb the control laws used for guiding the munition, meaning that the firing precision is unimpaired by the removal of the nosecone according to the invention.

FIG. 7 shows a face-on view of the munition after the two half-nosecones have been ejected.

The small-sized separable ejectable nosecone according to the invention allows the guided munition homing head optics to be protected until such time as the nosecone portions are ejected and also during the storage and logistic phases and during the other operational (tactical) phases.

By design, the two half-nosecones may be identical or may be joined together by a flexible and pliable zone which thus makes the two half-nosecones easier to produce as a single piece, for example by plastic injection molding.

The separable ejectable nosecone embodiment described hereinabove is nonlimiting and the number n of nosecone portions may be greater than 2. For example, FIG. 8 shows a face-on view of a separable ejectable nosecone according to the invention produced from three identical contiguous nosecone portions C1, C2, C3 (n=3) distributed about the axis ZZ′ and assembled along planes of assembly P1, P2, P3 which are 120 degrees apart.

FIG. 9 shows another exemplary embodiment of the separable ejectable nosecone according to the invention comprising four identical contiguous nosecone portions C1, C2, C3, C4 which are assembled along planes of assembly P1, P2 which are 90 degrees apart.

1. A separable ejectable protective nosecone for a guided munition comprising a munition body of cylindrical shape of longitudinal axis ZZ′ having a munition body front end comprising a central part intended to be directed toward a target, comprising:
n nosecone portions C1, C2, . . . Ci, . . . Cn of the same shape, distributed about said longitudinal axis ZZ′, intended to cover the front end of the munition body, n being an integer equal to or greater than 2, i being the rank of the nosecone portion, a nosecone portion Ci having at least one edge in contact with one edge of a nosecone portion contiguous with it in a respective plane of assembly P1, P2, P3 of two contiguous nosecone portions passing through the longitudinal axis ZZ′, one pyrotechnic device per nosecone portion C1, C2, C3, C4, each of the pyrotechnic devices comprising, along their longitudinal axis AA′, a pyrotechnic device body secured in terms of translational movement to the munition body, a pusher piston able to slide in a manner that is fluid-tight via one of its ends, along the longitudinal axis AA′, on the pyrotechnic device body, the free end of the pusher piston being in contact with the respective nosecone portion C1, C2, C3, C4 in order, when the n pyrotechnic devices are simultaneously activated, to separate the contacting edges of the n nosecone portions from their respective planes of assembly and to free the front end of the munition body, said nosecone further comprising an ovoid part at the front end of the munition body extending toward the rear of said munition body in the form of a frustoconical part of longitudinal axis ZZ′ comprising an edge that is circular around said ZZ′ and, in the zone where the ovoid part and the frustoconical part meet, weakening grooves of circular shape around the longitudinal axis ZZ′, there being an external weakening groove on the external surface side thereof and an internal weakening groove on the internal surface side thereof.

2. The separable ejectable protective nosecone as claimed in claim 1, wherein, n being equal to 2, the nosecone portions are half-nosecones (C1, C2), a lower half-nosecone (C1) and an upper half-nosecone (C2) the shapes of which exhibit symmetry about the plane of assembly (P1).

3. The separable ejectable protective nosecone as claimed in claim 1, wherein each nosecone portion is in contact with the pusher piston of a respective pyrotechnic device via a reaction finger solid with the nosecone portion.

4. The separable ejectable protective nosecone as claimed in claim 1, herein each pyrotechnic device comprises an igniter between the pyrotechnic device body and the pusher piston so that when activated it separates the pusher piston from the pyrotechnic device body and applies a separation force F to the respective nosecone portion.

5. The separable ejectable protective nosecone as claimed in claim 1, wherein the other free end of the pusher piston comprises a pusher piston head forming, on the same side as the pyrotechnic device body, a shoulder having a surface with a back slope intended to be in contact with another surface having the same back slope belonging to the reaction finger of said nosecone portion (C1, C2) and, at this same other free end of the pusher piston, on the side nearest the munition body, a longitudinal groove parallel to the axis AA′, a cylindrical pin adhered by one of its ends to the munition body being inserted via the other end into the longitudinal groove to limit the travel of the pusher piston of the pyrotechnic device when the igniter is activated.

6. The separable ejectable protective nosecone as claimed in claim 4, wherein the pyrotechnic device body comprises an electrical connection pin intended to receive electrical wires for activating the igniter.

7. The separable ejectable protective nosecone as claimed in claim 2, wherein the lower half-nosecone (C1) and upper half-nosecone (C2) each comprise a respective edge in contact in the plane of assembly P1, the lower half-nosecone (C1) comprising on its edge a longitudinal groove extending on each side of the axis ZZ′, the upper half-nosecone (C2) comprising on its edge, in a manner which is symmetric about the plane of assembly (P1), a longitudinal tenon extending on each side of the axis ZZ′ with the same external dimensions as the longitudinal groove in order to form a nested connection of the tenon/mortise type.

8. The separable ejectable protective nosecone as claimed in claim 1, further comprising, surrounding the frustoconical part, a retaining ring that holds the n nosecone portions on the munition body, said retaining ring being held on the n nosecone portions by bonding, crimping or push fitting.

9. The separable ejectable protective nosecone as claimed in claim 8, wherein the retaining ring comprises, on one side, a tapered edge in the region of the frustoconical part having the weakening grooves and, on the opposite side, toward the rear of the munition, a circular edge in the plane P4 perpendicular to the longitudinal axis ZZ′.

10. The separable ejectable protective nosecone as claimed in claim 9, wherein, on the side of the frustoconical part, it comprises a circular nosecone edge, the circular nosecone edge and the circular edge of the retaining ring being in abutment, in the same plane P4, against a shoulder, in a plane perpendicular to the longitudinal axis ZZ′, of the munition body.

11. A guided munition, further comprising a separable ejectable protective nosecone as claimed in claim 1.

12. The guided munition as claimed in claim 11, wherein, with the smallest diameter of the frustoconical part of the nosecone being on the side facing toward the rear of the munition to create a back slope a that holds the half-nosecones on the munition body, the munition body comprises a circular zone around the axis ZZ′ the external surface of which circular zone has the same retaining back slope as the internal surface of the frustoconical part so as to hold the two half-nosecones on the munition body.
